(19) United States
(12) Patent Application Publication
(10) Pub. No.: US 2022/0208211 A1
(43) Pub. Date: Jun. 30, 2022

(54) DISPLAY DEVICE AND DISPLAY METHOD

(71) Applicant: PANASONIC INTELLECTUAL PROPERTY MANAGEMENT CO., LTD., Osaka (JP)

(72) Inventor: Ryota FUJII, Fukuoka (JP)

(73) Assignee: PANASONIC INTELLECTUAL PROPERTY MANAGEMENT CO., LTD., Osaka (JP)

(21) Appl. No.: 17/559,426

(22) Filed: Dec. 22, 2021

(30) Foreign Application Priority Data
Dec. 25, 2020 (JP) 2020-217787

(51) Int. Cl. G10L 21/12; G06N 20/00; G10L 21/14

(52) U.S. Cl. CPC G10L 21/12; G10L 21/14; G06N 20/00

(57) ABSTRACT

A display device includes a processor, a memory, and a monitor. The processor is configured to display a signal waveform of voice data on the monitor and then receive a designation operation of a designated section designated by a user on the voice data, determine one or more target sections in the designated section, generate a screen in which a frame line indicating each of the one or more determined target sections is superimposed on the signal waveform, and output the screen to the monitor.

### CROSS-REFERENCE TO RELATED APPLICATIONS

This application is based on and claims priority under 35 USC 119 from Japanese Patent Application No. 2020-217787 filed on Dec. 25, 2020, the contents of which are incorporated herein by reference.

### TECHNICAL FIELD

The present disclosure relates to a display device and a display method.

### BACKGROUND ART

JP-A-2013-61733 discloses a device configured to find and output a partial form of time-series data or a combination of the time-series data from time-series data which is a sequence of numerical values recorded in accordance with time, and the device has a function capable of inputting a shape of the time-series data assumed by a user by a pointing device and a method capable of designating a combination of shapes of the time-series data.

### SUMMARY OF INVENTION

The present disclosure has been made in view of the above situation in the related art, and an object of the present disclosure is to provide a display device and a display method that provide a voice section as a target to a user in an easy-to-understand manner. An another object of the present disclosure is to provide a display device and a display method that support improvement of convenience of annotation work of the user.

Aspect of non-limiting embodiments of the present disclosure relates to provide a display device including a processor, a memory, and a monitor, in which the processor is configured to display a signal waveform of voice data on the monitor and then receive a designation operation of a designated section designated by a user on the voice data, determine one or more target sections in the designated section, and generate a screen in which a frame line indicating each of the one or more determined target sections is superimposed on the signal waveform, and output the screen to the monitor.

Also, another aspect of non-limiting embodiments of the present disclosure relates to provide a display device including a monitor that displays voice data, an input unit configured to receive a designation operation of a designated section by a user on voice data in a state that a signal waveform of the voice data is displayed on the monitor, and a processor configured to determine one or more target sections from the designated section, generate a screen in which a frame line indicating each of the one or more determined target sections is superimposed on the signal waveform, and output the screen to the monitor.

Further, another aspect of non-limiting embodiments of the present disclosure relates to provide a display method performed by a terminal device that generates data used for voice identification, the display method including: receiving a designation operation of a designated section designated by a user on voice data in a state that a signal waveform of the voice data is displayed on a monitor, and then determining one or more target sections in the designated section, and generating a screen illustrating the one or more determined target sections on the signal waveform, and outputting the screen.

According to aspects of the present disclosure, it is possible to present a voice section as a target to a user in an easy-to-understand manner and to support improvement of convenience of annotation work of the user.

### BRIEF DESCRIPTION OF DRAWINGS

FIG. 1 is a block diagram showing an example of an internal configuration of a terminal device according to an embodiment.

FIG. 2 is a block diagram showing a functional configuration example of annotation editing software of the terminal device according to the embodiment.

FIG. 3 is a flowchart showing an example of an operation procedure in a user operation reception unit.

FIG. 4 is a flowchart showing an example of an automatic determination procedure of a learning target section in a learning target section automatic determination unit.

FIG. 5 is a diagram showing a designated section designated by a user and each of a plurality of learning target sections.

FIG. 6 is a diagram showing an example of the learning target section.

FIG. 7 is a flowchart showing an example of an excluding processing procedure of the learning target section in a learning target section automatic correction unit.

FIG. 8 is a flowchart showing an example of a correcting processing procedure of the learning target section in the learning target section automatic correction unit.

FIG. 9 is a diagram showing an example of the learning target section after the excluding processing and the correcting processing.

FIG. 10 is a diagram showing an example of an annotation editing screen.

### DESCRIPTION OF EMBODIMENTS

### Background of Embodiment

In recent years, there is a voice identification application using artificial intelligence (AI). The voice identification application identifies a specific voice (for example, a voice occurring in a city, an abnormal voice, or the like), or a person's emotion, based on voices collected through a microphone. However, in such a voice identification application, it is necessary to perform an annotation processing to make a voice as an identification target identifiable, and to indicate the voice as the identification target among the voices collected as machine learning data.

Here, as an annotation method for voice identification, there is a method of associating a voice with a sentence, associating one label (for example, a label indicating the identification target) with one voice file, or associating one learning target section based on a start point and an end point on an optionally selected time axis in one voice file with one label. Since the annotation method of associating the voice with the sentence is manually performed by a user, a large amount of work is required.

However, when the learning target section with which the label is associated contains a section that is inappropriate for learning (for example, a silent section equal to or longer than a predetermined time), the voice identification application may not be able to perform effective learning. Specifically, a voice identification processing using the AI is executed for a voice in a fixed time section (for example, 100 milliseconds, 1 second, and the like), when a learning target section of any length is learnt, the selected learning target section is divided into fixed time sections, and learning and estimation of the identification target are executed for each divided fixed time section. When the divided fixed time section is an inappropriate section for learning, the inappropriate section is learnt as the identification target, so that the voice identification application may not be able to perform the effective learning. Further, since the learning of the voice identification application is executed as an internal processing, it is not possible for the user to know whether a section inappropriate for learning is included in the learning target section.

Hereinafter, an embodiment in which configurations and functions of a voice learning support device and a voice learning support method according to the present disclosure are specifically disclosed will be described in detail with reference to the drawings as appropriate. However, an unnecessarily detailed description may be omitted. For example, a detailed description of a well-known matter or a repeated description of substantially the same configuration may be omitted. This is to avoid unnecessary redundancy in the following description and to facilitate understanding of those skilled in the art. The accompanying drawings and the following descriptions are provided for those skilled in the art to have a thorough understanding of the present disclosure, and are not intended to limit a subject matter recited in the claims.

Here, terms used in the following description are merely examples, and are not intended to be limiting. For example, the terms “section” and “position” include reproduction time in a voice data 12B.

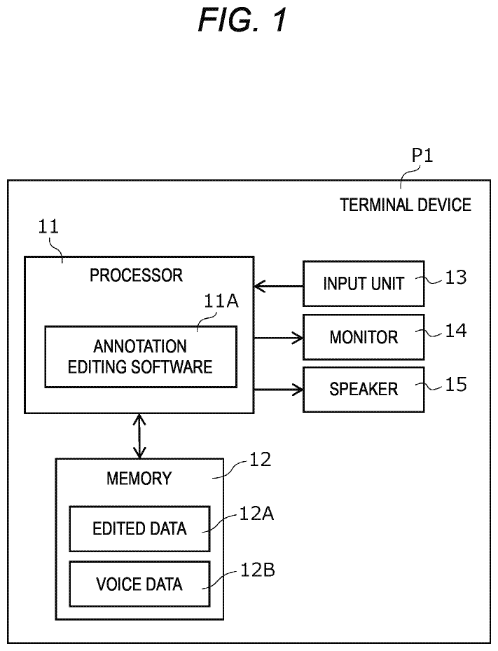

First, an internal configuration of a terminal device P1 as an example of the voice learning support device according to the embodiment will be described with reference to FIG. 1. FIG. 1 is a block diagram showing an example of the internal configuration of the terminal device P1 according to the embodiment.

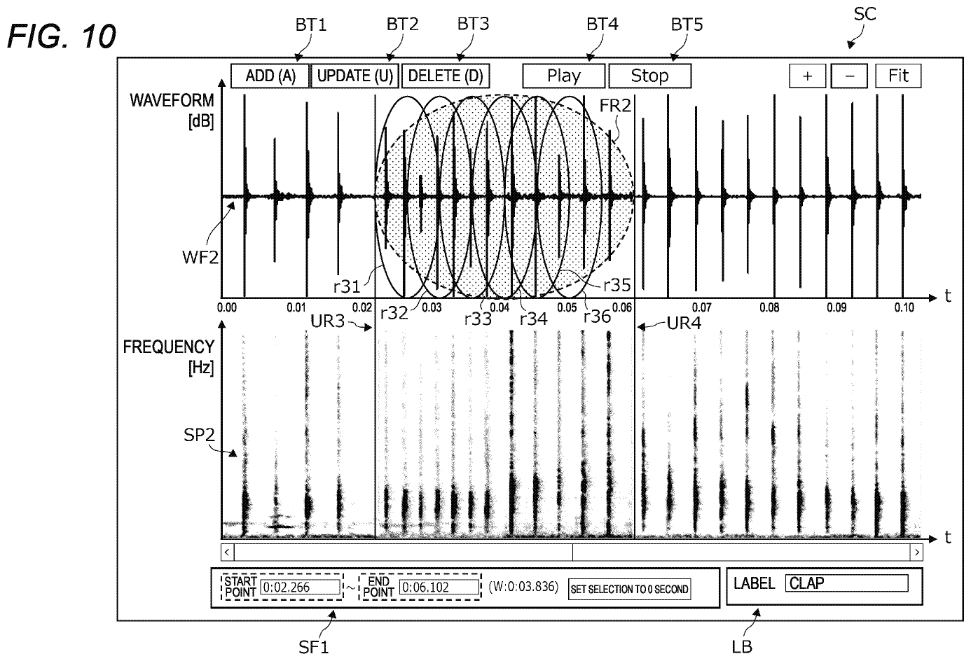

The terminal device P1 can receive a user operation, and uses artificial intelligence (AI) to generate learning data (so-called teacher data) for machine learning for identifying a specific voice from any voice data 12B. The terminal device P1 is capable of supporting annotation work on voice data by a user operation, and for example, and executes a processing of selecting the learning target section such as dividing any voice section (machine learning section) designated as the learning target section by a user operation into one or more learning target sections more suitable for the machine learning, or correcting the learning target section that is more suitable for the machine learning. The terminal device P1 generates an annotation editing screen SC (see FIG. 10) in which one or more learning target sections determined on the voice data are indicated by frame lines, and displays the annotation editing screen SC on the monitor 14, thereby presenting the one or more learning target sections to the user.

The terminal device P1 can receive the user operation, and is implemented by, for example, a smartphone, a tablet terminal, a personal computer (PC), a notebook PC, or the like. The terminal device P1 includes a processor 11, a memory 12, an input unit 13, a monitor 14, and a speaker 15. In a following description, the terminal device P1 shows an example in which the voice data 12B is stored in the memory 12 in advance. For example, the voice data 12B may be acquired from an external storage medium such as a compact disc read only memory (CD-ROM), a USB memory, an SD (registered trademark) card, a smartphone, a voice recorder, or the like, and the voice data 12B may be acquired from a device capable of collecting voice such as a microphone (not shown) connected so that data communication is possible. Further, the terminal device P1 may include a communication unit (not shown), and may acquire the voice data 12B from an external terminal (for example, a server, another terminal device, or the like) connected by the communication unit via Internet (not shown) so that the data communication is possible.

The processor 11 as an example of an output unit is formed using, for example, a central processing unit (CPU) or a field programmable gate array (FPGA), and performs various processing and controls in cooperation with the memory 12. Specifically, the processor 11 refers to programs and data held in the memory 12 and executing the programs to implement functions of each unit or functions of annotation editing software 11A.

The processor 11 may generate learning data for identifying a specific voice from any voice data 12B using the AI based on edited data 12A after the annotation work generated by the annotation editing software 11A. The learning for generating the learning data may be performed by using one or more statistical classification techniques. Examples of the statistical classification techniques include linear classifiers, support vector machines, quadratic classifiers, kernel estimation, decision trees, artificial neural networks, Bayesian techniques and/or networks, hidden Markov models, binary classifiers, multi-class classifiers, a clustering technique, a random forest technique, a logistic regression technique, a linear regression technique, a gradient boosting technique, and the like. However, the statistical classification techniques used are not limited thereto.

The memory 12 includes a storage device including a semiconductor memory such as a random access memory (RAM) and a read only memory (ROM) and a storage device such as a solid state drive (SSD) or an HDD. The memory 12 stores edited data 12A and the voice data 12B. When the processor 11 generates the learning data, the memory 12 may store the generated learning data. The edited data 12A referred to here is data generated by the annotation editing software 11A, is data in which information of the voice data 12B, information of a designated section of the voice data 12B as a target of the machine learning (specifically, information of a position of a start point and a position of an end point of the designated section), information of a start point and an end point of each of one or more learning target sections determined for the designated section, and a label name of the designated section are associated with each other.

The input unit 13 can receive a user operation and is a user interface configured using, for example, a mouse, a keyboard, a touch panel, or the like. The input unit 13 converts the received user operation into an electrical signal (control command) and outputs the electrical signal to the processor 11.

The monitor 14 is formed with a display such as a liquid crystal display (LCD) or an organic electroluminescence (EL). The monitor 14 displays the annotation editing screen SC (see FIG. 10) output from the processor 11.

When the user performs a reproduction operation of the voice data 12B, the speaker 15 outputs a voice of the voice data 12B.

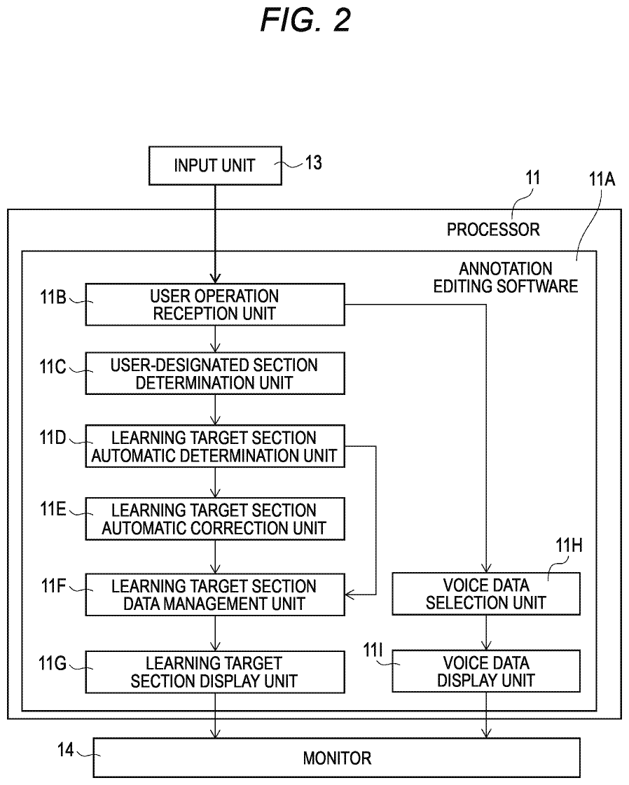

Next, a functional configuration of the annotation editing software 11A will be described with reference to FIG. 2. FIG. 2 is a block diagram showing a functional configuration example of the annotation editing software 11A of the terminal device P1 according to the embodiment.

The annotation editing software 11A includes a user operation reception unit 11B, a user-designated section determination unit 11C, a learning target section automatic determination unit 11D, a learning target section automatic correction unit 11E, a learning target section data management unit 11F, a learning target section display unit 11G, a voice data selection unit 11H, and a voice data display unit 11I. A configuration of the learning target section automatic correction unit 11E in the annotation editing software 11A is not essential and may be omitted, or may be added as an optional function in accordance with a user's request.

The user operation reception unit 11B receives a designation operation by the user for any section of the voice data 12B in which the machine learning is to be performed selected as a target for annotation editing by the user. The user operation reception unit 11B receives an operation for designating a start point UR1 and an end point UR2 of a designated section UR designated by the user operation, and outputs information of the start point UR1 and the end point UR2 to the user-designated section determination unit 11C.

The user-designated section determination unit 11C determines the designated section UR based on the information of the start point UR1 and the end point UR2 of the designated section UR output from the user operation reception unit 11B. The user-designated section determination unit 11C outputs information of the determined designated section UR to the learning target section automatic determination unit 11D.

The learning target section automatic determination unit 11D determines one or more learning target sections based on the information of the designated section UR output from the user-designated section determination unit 11C. The learning target section automatic determination unit 11D outputs information of the determined learning target sections to the learning target section automatic correction unit 11E. Here, when the learning target section automatic correction unit 11E is not included in the configuration of the annotation editing software 11A, the learning target section automatic determination unit 11D may output the information of the determined learning target section to the learning target section data management unit 11F. The learning target section automatic determination unit 11D may output the information of the learning target section determined by the learning target section automatic correction unit 11E and the learning target section data management unit 11F.

The learning target section automatic correction unit 11E determines whether each of one or more learning target sections output from the learning target section automatic determination unit 11D is an effective learning target section for the machine learning. When it is determined that the learning target section is not an effective learning target section for the machine learning, the learning target section automatic correction unit 11E performs a processing of removing the learning target section from the target of the machine learning (that is, an excluding processing of the learning target section), or performs a processing of correcting a section of the learning target section. All processing executed by the learning target section automatic correction unit 11E may be executed or only a processing of any one processing designated by the user may be executed. The learning target section automatic correction unit 11E outputs information of the one or more learning target sections after the excluding processing or a correcting processing to the learning target section data management unit 11F.

The learning target section data management unit 11F manages the information of the designated section UR designated by the user (that is, the information of the start point UR1 and the end point UR2 of the designated section UR), the information of the start point and the end point of each of one or more learning target sections determined for the designated section UR, and a label name input to a label input field LB (refer to FIG. 10) in association with each other, and outputs the information to the learning target section display unit 11G. The learning target section data management unit 11F may generate the edited data 12A based on the information of the designated section UR, the information of the start point and the end point of each of the one or more learning target sections, and the label name, and output the edited data 12A to the memory 12 and register the edited data 12A in the memory 12.

The learning target section display unit 11G generates the annotation editing screen SC (see FIG. 10) in which a frame line indicating each of one or more registered learning target sections is superimposed on at least one of a signal waveform data WF1 or a frequency spectrum data SP1 of the voice data 12B selected by the user based on the information of the designated section UR and the information of the start point and the end point of each of the one or more learning target sections output from the learning target section data management unit 11F. The learning target section display unit 11G outputs the generated annotation editing screen SC to the monitor 14 to be displayed.

The voice data selection unit 11H refers to the memory 12 and acquires the voice data 12B based on the information of the voice data 12B output from the user operation reception unit 11B. The voice data selection unit 11H outputs the acquired voice data 12B to the voice data display unit 11I.

The voice data display unit 11I generates an annotation editing screen (not shown) including the signal waveform data WF1 and the frequency spectrum data SP1 of the voice data 12B based on the voice data 12B output from the voice data selection unit 11H, and outputs the generated annotation editing screen to the monitor 14 to be displayed. The annotation editing screen (not shown) generated by the voice data display unit 11I is a screen displayed on the monitor 14 before receiving a designation operation of the designated section UR by the user.

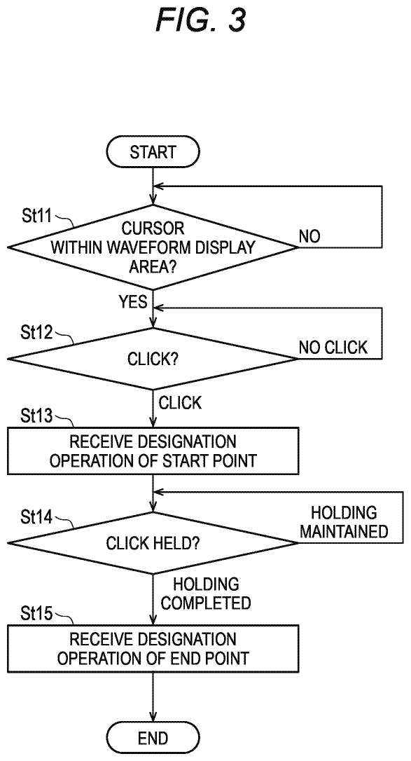

First, an operation procedure of the user operation reception unit 11B will be described with reference to FIG. 3. FIG. 3 is a flowchart showing an example of the operation procedure of the user operation reception unit 11B in the terminal device P1 according to the embodiment. The operation procedure of the user operation reception unit 11B described with reference to FIG. 3 will be described as an example in which the user operation is received by a mouse, but it is needless to say that the operation procedure is not limited to this.

First, the processor 11 activates the annotation editing software 11A based on a user operation. The user operation reception unit 11B receives a selecting operation of the voice data 12B as a target of the annotation editing based on the user operation received by the input unit 13. The user operation reception unit 11B outputs information of the selected voice data 12B to the voice data selection unit 11H.

The voice data selection unit 11H refers to the memory 12 and acquires the voice data 12B based on the information of the voice data 12B output from the user operation reception unit 11B. The voice data selection unit 11H outputs the acquired voice data 12B to the voice data display unit M. The voice data display unit 11I generates the annotation editing screen (not shown) including the signal waveform data WF1 of the voice data 12B and the frequency spectrum data SP1 of the voice data 12B based on the voice data 12B output from the voice data selection unit 11H, and outputs the generated annotation editing screen to the monitor 14 to be displayed. In the signal waveform data WF1, a vertical axis represents a voice pressure level, and a horizontal axis represents time. In the frequency spectrum data SP1, a vertical axis represents frequency, and a horizontal axis represents time.

The user operation reception unit 11B determines, based on a control command transmitted from the input unit 13 capable of receiving the user operation, whether a position of a cursor interlocked with the mouse operated by the user is within a waveform display area (St11). The waveform display area referred to here is an area including at least one of a display area AR1 of the signal waveform data WF1 and a display area AR2 of the frequency spectrum data SP1 on the annotation editing screen.

When it is determined that the position of the cursor interlocked with the mouse operated by the user is within the waveform display area in the processing of step St11 (St11, YES), the user operation reception unit 11B determines whether the user clicks the mouse in a state where the cursor is at any position within the waveform display area (St12). On the other hand, when it is determined that the position of the cursor interlocked with the mouse operated by the user is not within the waveform display area in the processing of step St11 (St11, NO), the user operation reception unit 11B returns to the processing of step St11 again.

When it is determined that the user clicks the mouse in the state where the cursor is at an any position within the waveform display area in the processing of step St12 (St12, YES), the user operation reception unit 11B receives a designation operation of the start point UR1 in the designated section UR used for the machine learning (St13), and outputs time of the voice data 12B corresponding to the position of the cursor where the operation is performed to the user-designated section determination unit 11C. On the other hand, when it is determined that the user does not click the mouse in the state where the cursor is at any position within the waveform display area in the processing of step St12 (St12, NO), the user operation reception unit 11B returns to the processing of step St12.

The user operation reception unit 11B determines whether a state where the user clicks the mouse is held (maintained) (St14). When it is determined that the state where the user clicks (selects) the mouse is held (maintained) in the processing of step St14 (St14, YES), the user operation reception unit 11B returns to the processing of step St14. On the other hand, when it is determined that the state where the user clicks (selects) the mouse is completed in the processing of step St14 (St14, NO), the user operation reception unit 11B receives a designation operation of the end point UR2 in the designation section UR used for the machine learning (St15), and outputs time of the voice data 12B corresponding to the position of the cursor where the operation is performed to the user-designated section determination unit 11C.

The user-designated section determination unit 11C associates the start point UR1 and the end point UR2 of the designated section UR output from the user operation reception unit 11B, and determines one designated section UR designated by the user. The user-designated section determination unit 11C outputs the information of the determined designated section UR to the learning target section automatic determination unit 11D. The user operation reception unit 11B may receive the designation operation of the start point UR1 and the end point UR2 of the designated section UR by an input operation of time corresponding to the start point UR1 and time corresponding to the end point UR2. For example, in such a case, the user operation reception unit 11B receives the input operation of the time corresponding to the start point and the end point in the annotation editing screen SC (see FIG. 10) displayed on the monitor 14. When it is determined that the time corresponding to the start point and the end point is input in an input field SF1 in which the input operation of the time corresponding to the start point and the end point can be received, the user operation reception unit 11B receives the input operation of one designated section by the user. The user-designated section determination unit 11C determines one designated section based on the time corresponding to the start point and the end point input to the input field SF1.

In a setting of the start point UR1 and the end point UR2 of the designated section UR, the user operation reception unit 11B may automatically correct the time of the designated start point and end point to time in every predetermined time (for example, 0.1 second, 0.5 second, and the like).

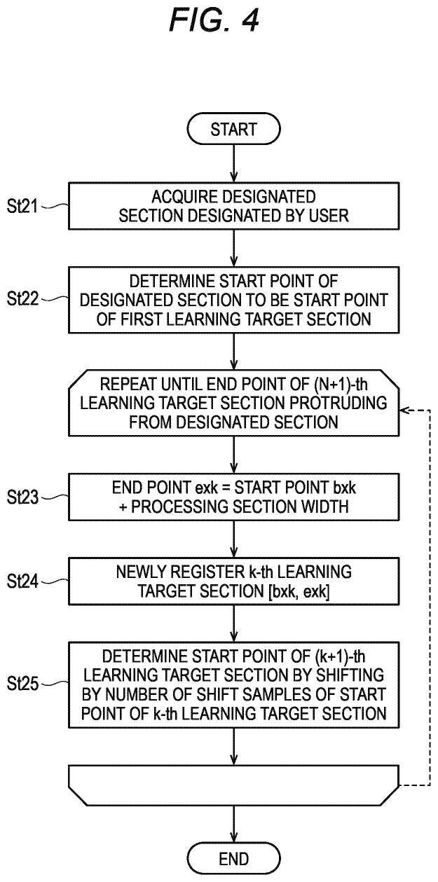

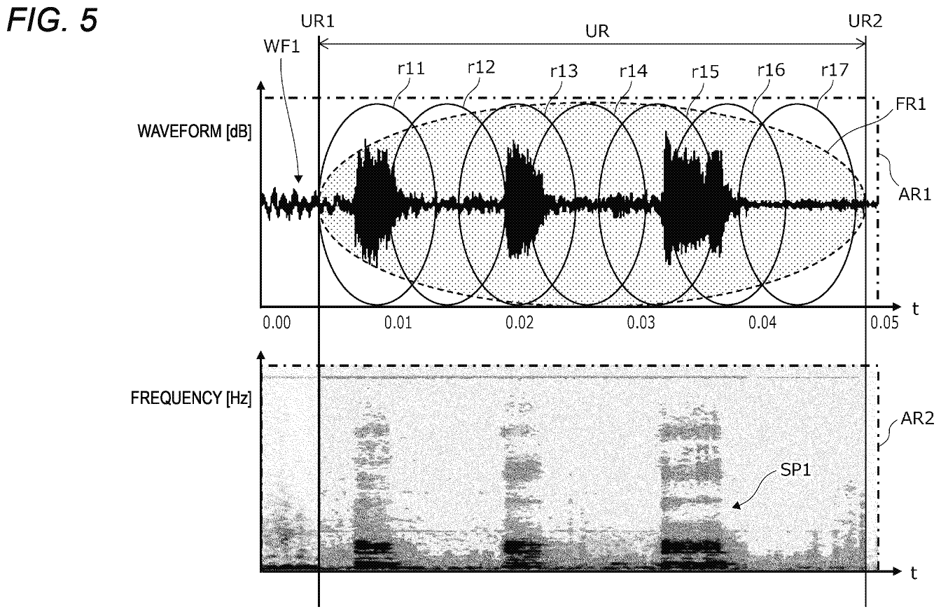

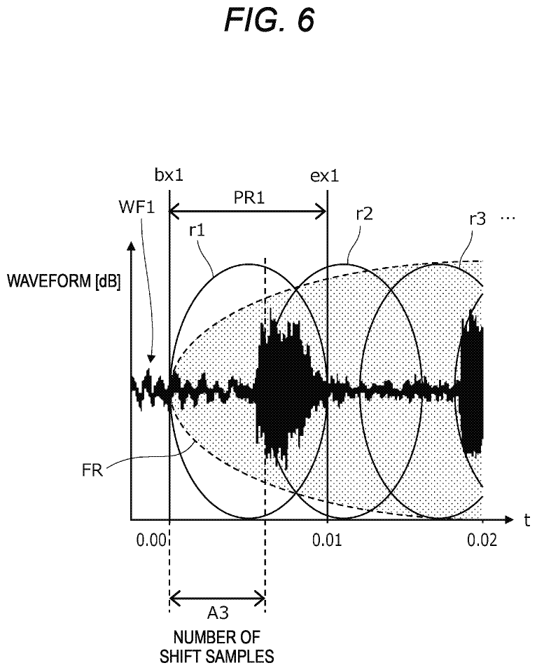

Next, an operation procedure of the learning target section automatic determination unit 11D will be described with reference to FIGS. 4 to 6. FIG. 4 is a flowchart showing an example of an automatic selecting procedure of the learning target section in the learning target section automatic determination unit 11D. FIG. 5 is a diagram showing the designated section UR designated by the user and each of a plurality of learning target sections. FIG. 6 is a diagram showing an example of the learning target section.

Although a frame line FR1 indicating the designated section UR and frame lines r11, r12, r13, r14, r15, r16, and r17 indicating the plurality of learning target sections shown in FIG. 5 are superimposed only on the signal waveform data WF1 as an example, the frame lines may be superimposed on the frequency spectrum data SP1, or may be superimposed on each of the signal waveform data WF1 and the frequency spectrum data SP1. In the example shown in FIG. 5, a shape of each of the frame lines FR1, and r11 to r17 is elliptical, but it is needless to say that the shape is not limited to this. The shape of each of the frame lines FR1, r11 to r17 may be a shape other than a rectangular shape (for example, a triangle, a rhombus, or the like). The shape of the frame line FR1 indicating the designated section and the shapes of the frame lines r11 to r17 indicating the respective learning target sections may not be the same shape. Another example of the shape of the frame line will be described below. The shape of the frame line may be any shape formed by one or more straight lines and one or more curves (for example, a semicircle, a shape obtained by cutting an ellipse at any position and angle, or the like), or any shape formed by a plurality of curves. For example, the frame line having an elliptical shape may be formed by two curves, or may be formed by two curves and two straight lines. The shape of the frame line may be a shape having one or more acute angles or obtuse angles. Further, the shape of the frame line may be, for example, a shape having one or more curves and one or more acute angles or obtuse angles such as a fan shape.

The shape of the frame line may be a shape formed by an upper side portion and a lower side portion, and may be a shape in which the upper side portion and the lower side portion are non-parallel to each other. The upper side portion and the lower side portion referred to here include one or more straight lines, one or more curves, or one or more straight lines and one or more curves. For example, when the shape of the frame line is a triangle, the frame line is formed by the upper side portion including any two straight lines among three straight lines forming the triangle, and the lower side portion including one straight line. One or more straight lines or one or more curves included in the upper side portion and the lower side portion are non-parallel to the horizontal axes (that is, time axes) of the signal waveform data WF1 and the frequency spectrum data SP1.

Further, the shape of the frame line may be a shape having a length different from a length in a direction corresponding to the horizontal axes of the signal waveform data WF1 and the frequency spectrum data SP1 and a length in a direction corresponding to the vertical axes of the signal waveform data WF1 and the frequency spectrum data SP1 at a center point of any shape formed by the frame line. Accordingly, the terminal device P1 can improve a visibility of adjacent frame lines.

In FIG. 6, only a start point and an end point of a first learning target section are illustrated, and an illustration of each of a start point and an end point of second and subsequent learning target sections is omitted.

The learning target section automatic determination unit 11D acquires the information of the designated section UR output from the user-designated section determination unit 11C (St21). The learning target section automatic determination unit 11D starts a determining processing of the first learning target section based on the acquired information of the designated section UR. The learning target section automatic determination unit 11D determines the start point UR1 of the designated section UR to be a start point bx1 of the first learning target section (St22).

The learning target section automatic determination unit 11D determines a position of a predetermined processing section width PR1 (that is, a time range to be a learning target) from the start point bx1 of the set first learning target section as an end point ex1 of the first learning target section (St23). The number of samples included in the predetermined processing section width PR1 referred to here is, for example, 1500 samples, 1600 samples, or the like. The predetermined processing section width PR1 may be a width (number of samples) larger than or smaller than the number of shift samples A3 to be described later, may be set to any value (number of samples) in advance by the user, or a predetermined value may be set based on a size of the designated section UR designated by the user. When the predetermined processing section width PR1 is smaller than the number of shift samples A3, the learning target section automatic determination unit 11D determines the learning target section while skipping some sections.

The learning target section automatic determination unit 11D newly registers a section [bx1, ex1] indicated by the start point bx1 and the end point ex1 of the determined first learning target section as the first learning target section (St24). A registration processing referred to here is a processing in which the learning target section automatic determination unit 11D outputs the information of one designated section UR and the information of the determined learning target section in association with each other to the learning target section data management unit 11F for storage.

The learning target section automatic determination unit 11D determines a start point bx2 (not shown) of the second learning target section at a position where the start point bx1 of the first learning target section is shifted by the number of shift samples A3 (St25). The number of samples of the number of shift samples A3 referred to here is, for example, the number of samples such as 30% or 40% of the processing section width PR1, and any number of samples may be set by the user. For example, the number of samples of the number of shift samples A3 is set to a smaller number of samples when the learning target section is set to a smaller section, and is set to a larger number of samples when the learning target section is set to a larger section.

The learning target section automatic determination unit 11D repeatedly performs the determining processing of the start point and the end point of the learning target section shown in step St23 to step St25 and the registration processing of the determined one or more learning target sections. When it is determined that an end point ex(N+1) of an (N+1)-th (N is an integer equal to or greater than 1) learning target section protrudes from the designated section UR designated by the user in the processing of step St24, the learning target section automatic determination unit 11D registers each of N learning target sections from the first learning target section to an N-th learning target section with respect to the designated section UR, and ends a determining processing of the learning target section.

Specifically, after a seventh learning target section is newly registered, the learning target section automatic determination unit 11D in the example shown in FIG. 5 determines that an end point of an eighth learning target section protrudes from the end point UR2 of the designated section UR designated by the user, and registers seven learning target sections from the first learning target section to the seventh learning target section with respect to the designated section UR.

The learning target section automatic determination unit 11D associates information of the start point UR1 and the end point UR2 of one designated section UR with information of the determined one or more learning target sections, and outputs the information to the learning target section automatic correction unit 11E and the learning target section data management unit 11F.

The learning target section display unit 11G superimposes the frame line FR1 surrounding the start point UR1 to the end point UR2 on at least one of data of the signal waveform data WF1 and the frequency spectrum data SP1 based on the information of the start point UR1 and the end point UR2 of one designated section UR output from the learning target section data management unit 11F.

The learning target section display unit 11G superimposes the frame line r11 to r17 surrounding the learning target section from the start point to the end point on at least one of data of the signal waveform data WF1 and the frequency spectrum data SP1 based on the information of the start point and the end point of each of one or more learning target sections output from the learning target section data management unit 11F. The learning target section display unit 11G generates the annotation editing screen in which the frame lines FR1, and r11 to r17 indicating the designated section and one or more learning target sections are superimposed, and outputs the annotation editing screen to the monitor 14.

Here, in the example shown in FIGS. 5 and 6, the frame line r11 indicates the first learning target section, and surrounds the first learning target section from the start point bx1 to the end point ex1. Similarly, the frame line r12 surrounds the second learning target section from the start point bx2 (not shown) to an end point ex2 (not shown). The frame line r13 surrounds a third learning target section from a start point bx3 (not shown) to an end point ex3 (not shown). The frame line r14 surrounds a fourth learning target section from a start point bx4 (not shown) to an end point ex4 (not shown). The frame line r15 surrounds a fifth learning target section from a start point bx5 (not shown) to an end point ex5 (not shown). The frame line r16 surrounds a sixth learning target section from a start point bx6 (not shown) to an end point ex6 (not shown). The frame line r17 surrounds a seventh learning target section from a start point bx7 (not shown) to an end point ex7 (not shown).

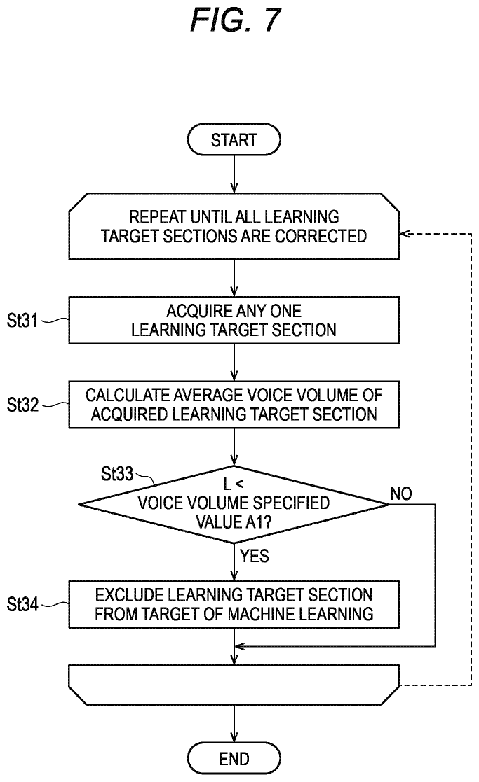

Next, an excluding processing procedure executed by the learning target section automatic correction unit 11E will be described with reference to FIG. 7. FIG. 7 is a flowchart showing an example of the excluding processing procedure of the learning target section in the learning target section automatic correction unit 11E.

The learning target section automatic correction unit 11E acquires information of any one learning target section of the one or more learning target sections determined by the learning target section automatic determination unit 11D (St31). Here, as an example, an example in which the learning target section automatic correction unit 11E acquires information of a k-th learning target section and corrects a section of the k-th learning target section will be described.

The learning target section automatic correction section 11E calculates an average voice volume L of the acquired k-th learning target section (St32), and determines whether the calculated average voice volume L is less than a voice volume specified value A1 (St33). The voice volume specified value A1 referred to here may be, for example, a fixed value determined based on preset conditions such as −50 dB full scale when the voice data 12B is a 16-bit digital voice. The voice volume specified value A1 may be a value obtained by adding a predetermined voice pressure level (for example, 6 dB, 8 dB, or the like) to a minimum voice pressure level of the voice data 12B, or may be a value obtained by determining a voice pressure level to be added based on the value of the minimum voice pressure level of the voice data 12B and adding the predetermined voice pressure level determined to the minimum voice pressure level.

When it is determined that the calculated average voice volume L is less than the voice volume specified value A1 in the processing of step St33 (St33, YES), the learning target section automatic correction unit 11E excludes or removes the k-th learning target section from the target of the machine learning (St34), and ends the correcting processing for the k-th learning target section. On the other hand, when it is determined that the calculated average voice volume L is not less than the voice volume specified value A1 in the processing of step St33 (St33, NO), the learning target section automatic correction unit 11E determines that a deleting processing for the k-th learning target section is unnecessary, and omits the deleting processing.

The learning target section automatic correction unit 11E executes a processing shown in step St31 to step St34 for all learning target sections determined by the learning target section automatic determination unit 11D. When it is determined that the processing shown in step St31 to step St34 is executed for all the learning target sections, the learning target section automatic correction unit 11E ends the deleting processing shown in FIG. 7.

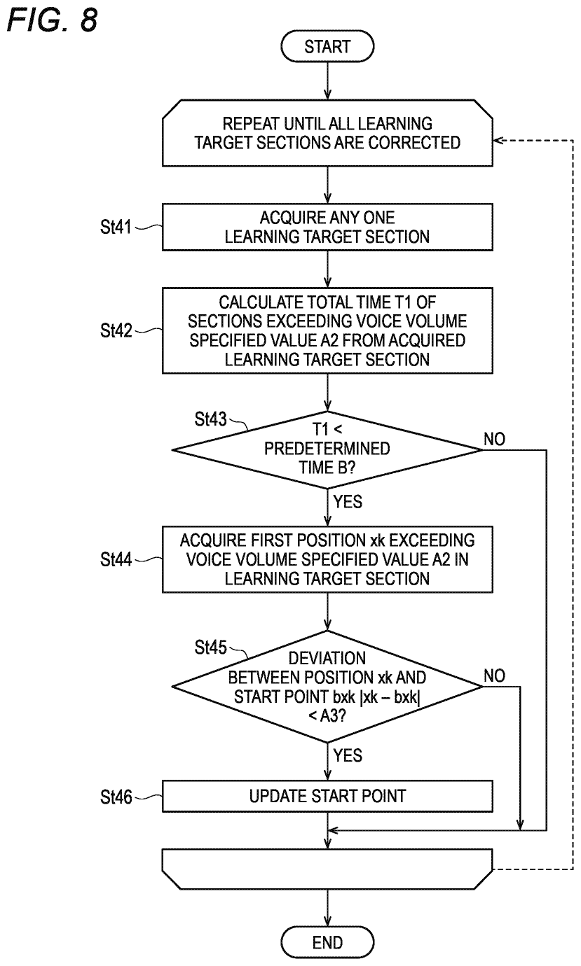

Next, a correcting processing procedure executed by the learning target section automatic correction unit 11E will be described with reference to FIG. 8. FIG. 8 is a flowchart showing an example of the correcting processing procedure of the learning target section in the learning target section automatic correction unit 11E.

The learning target section automatic correction unit 11E acquires the information of any one learning target section of the one or more learning target sections determined by the learning target section automatic determination unit 11D (St41). Here, as an example, the example in which the learning target section automatic correction unit 11E acquires information of the k-th learning target section and corrects the section of the k-th learning target section will be described.

The learning target section automatic correction unit 11E calculates a total time T1 of sections exceeding a voice volume specified value A2 from the acquired k-th learning target section (St42). The voice volume specified value A2 referred to here may be, for example, a fixed value determined based on preset conditions such as −50 dB full scale when the voice data 12B is a 16-bit digital voice. The voice volume specified value A2 may be a value obtained by adding a predetermined voice pressure level (for example, 6 dB, 8 dB, or the like) to a minimum voice pressure level of the voice data 12B, or may be a value obtained by determining a voice pressure level to be added based on the value of the minimum voice pressure level of the voice data 12B and adding the predetermined voice pressure level determined to the minimum voice pressure level. Further, the voice volume specified value A2 may be the same value as the voice volume specified value A1.

The learning target section automatic correction unit 11E determines whether the calculated total time T1 is less than a predetermined time B (St43). The predetermined time B referred to here is determined based on time from a start point bxk to an end point exk of the k-th learning target section, and is, for example, 40% or 50% of the time from the start point bxk to the end point exk.

When it is determined that the calculated total time T1 is less than the predetermined time B in the processing of step St43 (St43, YES), the learning target section automatic correction unit 11E extracts a section exceeding the voice volume specified value A2 in the k-th learning target section, and acquires information on a first position xk (time) of the extracted section (St44). On the other hand, when it is determined that the calculated total time T1 is not less than the predetermined time B in the processing of step St43 (St43, NO), the learning target section automatic correction unit 11E determines that the correcting processing for the k-th learning target section is unnecessary, and omits the correcting processing.

The learning target section automatic correction unit 11E calculates a difference section (deviation) between the acquired position xk and the start point bxk of the k-th learning target section. The learning target section automatic correction unit 11E determines whether the calculated difference section (deviation) is less than the number of shift samples A3 (St45).

When it is determined that the calculated difference section (deviation) is less than the number of shift samples A3 in the processing of step St45 (St45, YES), the learning target section automatic correction unit 11E updates (changes) the start point of the k-th learning target section to the position xk (St46). On the other hand, when it is determined that the calculated difference section (deviation) is not less than the number of shift samples A3 in the processing of step St45 (St45, NO), the learning target section automatic correction unit 11E determines that the correcting processing for the k-th learning target section is unnecessary, and omits the correcting processing.

The learning target section automatic correction unit 11E executes the correcting processing shown in step St41 to step St46 for all learning target sections determined by the learning target section automatic determination unit 11D. When it is determined that the correcting processing shown in step St41 to step St46 is executed for all the learning target sections, the learning target section automatic correction unit 11E ends the correcting processing shown in FIG. 8.

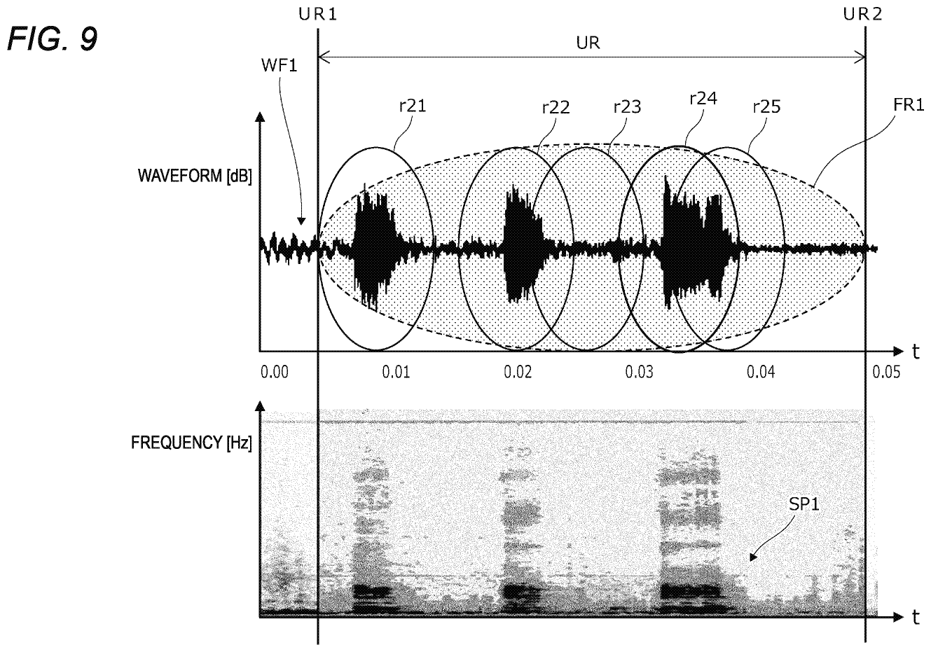

Here, an example of the learning target section after the excluding processing and the correcting processing by the learning target section automatic correction unit 11E will be described with reference to FIG. 9. FIG. 9 is a diagram showing an example of the learning target section after the excluding processing and the correcting processing. FIG. 9 is a diagram showing a part of the annotation editing screen after the seven learning target sections shown in FIG. 5 are corrected to five learning target sections by the excluding processing and the correcting processing by the learning target section automatic correction unit 11E.

In FIG. 9, each of the five learning target sections is indicated by five elliptical frame lines r21, r22, r23, r24, and r25. In the five learning target sections shown in FIG. 9, a first learning target section indicated by the frame line r21 corresponds to the first learning target section indicated by the frame line r11 shown in FIG. 5, a second learning target section indicated by the frame line r22 corresponds to the third learning target section indicated by the frame line r13 shown in FIG. 5, a third learning target section indicated by the frame line r23 corresponds to the fourth learning target section indicated by the frame line r14 shown in FIG. 5, a fourth learning target section indicated by the frame line r24 corresponds to the fifth learning target section indicated by the frame line r15 shown in FIG. 5, and a fifth learning target section indicated by the frame line r25 corresponds to the sixth learning target section indicated by the frame line r16 shown in FIG. 5.

Here, in the example shown in FIG. 9, the second learning target section indicated by the frame line r12 and the seventh learning target section indicated by the frame line r17 in FIG. 5 are deleted by being excluded from the target of the machine learning by the processing by the learning target section automatic correction unit 11E (specifically, the processing of step St34 shown in FIG. 7). In the example shown in FIG. 9, in the fourth learning target section indicated by the frame line r24, a position of a start point of the fifth learning target section indicated by the frame line r15 in FIG. 5 is changed by the processing by the learning target section automatic correction unit 11E (specifically, the processing in step St46 shown in FIG. 8).

As described above, the learning target section automatic correction unit 11E can exclude (delete) the learning target section determined to be ineffective by the machine learning in the learning target section determined by the learning target section automatic determination unit 11D. Accordingly, the learning target section automatic correction unit 11E can exclude a learning target section ineffective for the machine learning which is a silent section or a section having a low voice volume among the determined learning target sections.

The learning target section automatic correction unit 11E can correct the learning target section by changing the position of the start point of the learning target section determined not to be ineffective by the machine learning among the learning target sections determined by the learning target section automatic determination unit 11D. Accordingly, the learning target section automatic correction unit 11E can correct the section such that the determined learning target section includes more sections that are equal to or greater than the voice volume specified value A2, so that it is possible to determine an effective learning target section by the machine learning.

Next, the annotation editing screen SC displayed on the monitor 14 will be described with reference to FIG. 10. FIG. 10 is a diagram showing an example of the annotation editing screen SC.

The annotation editing screen SC includes at least a signal waveform data WF2, a frequency spectrum data SP2, and the label input field LB of the voice data 12B. When an input of a start point UR3 and an end point UR4 of the designated section designated by the user operation is received, a frame line FR2 indicating the designated section and frame lines r31, r32, r33, r34, r35, and r36 indicating the one or more learning target sections determined based on the designated section are superimposed on any one piece of data of the signal waveform data WF2 and the frequency spectrum data SP2 on the annotation editing screen SC.

In the example shown in FIG. 10, a shape of each of the frame lines FR2, and r31 to r36 is elliptical, but it is needless to say that the shape is not limited to this. The shape of each of the frame lines FR2, and r31 to r36 may be a shape other than a rectangular shape (for example, a triangle, a rhombus, or the like). The shape of the frame line FR2 indicating the designated section and the shapes of the frame lines r31 to r36 indicating the respective learning target sections may not be the same shape.

In the setting of the start point UR1 and the end point UR2 of the designated section UR, the user operation reception unit 11B may automatically correct the time of the designated start point and end point to time in every predetermined time (for example, 0.1 second, 0.5 second, and the like). For example, in the input field SF1 shown in FIG. 10, a position (time) of the start point UR3 of the designated section is input as “0:02.266” and a position (time) of the end point UR4 is input as “0:06.102”. In such a case, the user operation reception unit 11B may automatically correct the designated start point UR3 to “0:02” and the end point UR4 to “0:06” based on contents input to the input field SF1.

Accordingly, the annotation editing software 11A can support not only the designation operation of the start point and the end point of the designated section by the input to the input field SF1 above, but also the designation operation of the start point and the end point of the designated section by the user by automatically correcting the position (time) of the start point and the position (time) of the end point of the input designated section to well-cut time even when a user's hand shake or the like occurs during the designation operation using a user interface such as a mouse or a touch panel.

An add button BT1 is a button for performing an adding processing of a new designated section. When the add button BT1 is pressed (selected) by a user operation, the annotation editing software 11A receives addition of the new designated section.

An update button BT2 is a button for updating (changing) the designated section or registering (recording) a label name of the designated section input in the label input field LB or the like in association with the designated section, based on an input content of the time corresponding to the start point and the end point of the designated section input to the input field SF1.

A delete button BT3 is a button for deleting any one of the designated sections designated by the user operation or any one of the one or more learning target sections. When the delete button BT3 is pressed (selected) by a user operation in a state where any one of the designated sections or any one of the one or more learning target sections is selected (designated), the annotation editing software 11A deletes the designated section or the learning target section that is being selected (designated).

A play button BT4 is a button for reproducing the voice data 12B. When the play button BT4 is pressed (selected) by the user operation, the annotation editing software 11A reproduces the voice data 12B being edited.

A stop button BT5 is a button for stopping the reproduction of the voice data 12B. When the stop button BT5 is pressed (selected) by the user operation, the annotation editing software 11A stops the reproduction of the voice data 12B being edited.

The input field SF1 is an input field for receiving time corresponding to the start point and the end point of the designated section. When the time corresponding to the start point and the end point of the designated section is input to the input field SF1 by the user operation, the annotation editing software 11A determines a time period from the input start point to the end point as the designated section.

The label input field LB is an input field for receiving input of the label name set for each designated section. When a label name desired to be set in the designated section by the user is input to the label input field LB by the user operation, the annotation editing software 11A associates the input label name, the information of the designated section, and the information of the determined one or more learning target sections as the edited data 12A, outputs the edited data 12A to the memory 12 to be registered.

As described above, the terminal device P1 (an example of the voice learning support device) according to the embodiment includes the processor 11, the memory 12, and the monitor 14. The processor 11 displays a signal waveform of the voice data 12B (for example, the signal waveform data WF2 and the frequency spectrum data SP2 shown in FIG. 10) on the monitor 14, and then receives the designation operation of the designated section (specifically, the start point UR3 and the end point UR4 of the designated section) designated by the user on the voice data 12B, and determines one or more learning target sections used in the designated section designated used for the machine learning, and generates the annotation editing screen SC (an example of the screen) in which the frame line (for example, the frame lines r31 to r36 shown in FIG. 10) indicating each of the one or more determined learning target sections is superimposed on the signal waveform, and outputs the annotation editing screen SC to the monitor 14.

Accordingly, the terminal device P1 according to the embodiment automatically determines one or more learning target sections as the target of the machine learning for the designated section designated by the user, and displays the annotation editing screen SC in which the one or more determined learning target sections are superimposed on the signal waveform data WF2 or the frequency spectrum data SP2 of the voice data 12B, so that it is possible to present the learning target section as a voice section as the target of the machine learning to the user in an easy-to-understand manner and to support improvement of convenience of annotation work of the user.

As described above, the frame line indicating one or more learning target sections has a polygonal shape other than a rectangle. Accordingly, since a shape of the rectangular monitor 14 and the shape of the superimposed frame line are different, the terminal device P1 according to the embodiment can further improve a visibility of the one or more learning target sections displayed on the annotation editing screen SC. Since shapes (that is, rectangular shapes) of the display areas AR1 and AR2 of the signal waveform data WF2 and the frequency spectrum data SP2 displayed on the monitor 14 and the shape of the superimposed frame line are different, the terminal device P1 can further improve the visibility of the one or more learning target sections displayed on the annotation editing screen SC.

As described above, the frame line indicating the one or more learning target sections has a circular shape other than a perfect circle. Accordingly, since the shape of the rectangular monitor 14, or the shapes (that is, rectangular shapes) of the display areas AR1 and AR2 of the signal waveform data WF2 and the frequency spectrum data SP2, and the shape of the superimposed frame line are different, the terminal device P1 according to the embodiment can further improve the visibility of the one or more learning target sections displayed on the annotation editing screen SC. Since four sides of the rectangular monitor 14, four sides of the display areas AR1 and AR2 of the signal waveform data WF2 and the frequency spectrum data SP2, or straight lines indicating the horizontal axes the vertical axes of the signal waveform data WF2 and the frequency spectrum data SP2, and the frame line are non-parallel, the terminal device P1 can further improve the visibility of the one or more learning target sections displayed on the annotation editing screen SC. By superimposing the frame lines in the circular shape other than the perfect circle, the terminal device P1 can improve the visibility even if the adjacent frame lines overlap each other.

As described above, each of the one or more learning target sections determined by the terminal device P1 according to the embodiment is superimposed by the frame line having a shape of an ellipse, a triangle, or a rhombus. Accordingly, since the one or more learning target sections are indicated with the frame line having a shape other than a rectangular shape, and any one side of the four sides of the rectangular monitor 14 and the superimposed frame line are not parallel to each other, the terminal device P1 according to the embodiment can further improve the visibility of the one or more learning target sections displayed on the annotation editing screen SC. Since the sides of the rectangular display areas AR1 and AR2 of the signal waveform data WF2 and the frequency spectrum data SP2, or the vertical axes and the horizontal axes of the signal waveform data WF2 and the frequency spectrum data SP2, and the superimposed frame line on the monitor 14 are not parallel to each other (that is, non-parallel), the terminal device P1 can further improve the visibility of the one or more learning target sections displayed on the annotation editing screen SC.

As described above, the processor 11 in the terminal device P1 according to the embodiment calculates an average voice volume L for the one or more learning target sections, and removes the learning target section in which the calculated average voice volume L is determined to be less than the voice volume specified value A1 as a threshold value from the target of the machine learning. Accordingly, the terminal device P1 according to the embodiment can exclude the learning target section ineffective for the machine learning which is the silent section or the section having the low voice volume among the determined learning target sections.

As described above, in the learning target section in which the processor 11 in the terminal device P1 according to the embodiment determines that the total time T1 of the sections that are equal to or greater than the voice volume specified value A2 as the predetermined voice volume among the one or more learning target sections is less than the predetermined time B, the processor 11 corrects the time that is first equal to or greater than the voice volume specified value A2 to the start point of the learning target section. Accordingly, the terminal device P1 according to the embodiment can correct the position of the start point so that the silent section or the section having the low voice volume, which is ineffective for the machine learning, is not included in the learning target section. Therefore, the processor 11 can determine the learning target section in which the section included in the learning target section is automatically corrected to an effective section by the machine learning.

As described above, the processor 11 in the terminal device P1 according to the embodiment removes the learning target section designated by the user operation among the one or more learning target sections from the target of the machine learning. Accordingly, the terminal device P1 according to the embodiment can determine and register the one or more learning target sections that are effective by the machine learning by excluding the learning target section that is not intended by the user.

As described above, the processor 11 in the terminal device P1 according to the embodiment generates and outputs the annotation editing screen SC (an example of the screen) including the signal waveform data WF2 and the frequency spectrum data SP2 (an example of spectrum data) of the voice data 12B. Accordingly, the terminal device P1 according to the embodiment can display the signal waveform data WF2 and the frequency spectrum data SP2 of the voice data 12B in synchronization with each other.

As described above, the processor 11 in the terminal device P1 according to the embodiment generates the annotation editing screen SC (an example of the screen) in which the frame line (for example, the frame lines r31 to r36 shown in FIG. 10) indicating a range of each of the one or more learning target sections is superimposed on any one of the signal waveform data WF2 and the frequency spectrum data SP2 (an example of the spectrum data) of the voice data 12B designated by the user operation. Accordingly, terminal device P1 according to the embodiment can further improve usability in annotation editing work by the user. Accordingly, the annotation editing software 11A can support not only the designation operation of the start point and the end point of the designated section by the input to the input field SF1 above, but also the designation operation of the start point and the end point of the designated section by the user by automatically correcting the position (time) of the start point and the position (time) of the end point of the input designated section to well-cut time even when the user's hand shake or the like occurs during the designation operation using the user interface such as the mouse or the touch panel.

As described above, the processor 11 in the terminal device P1 according to the embodiment divides the voice data 12B for every predetermined time (for example, 0.1 second, 0.5 second, or the like), and corrects the time indicated by the start point or the end point of the designated section designated to a closest predetermined time among the divided predetermined time. Accordingly, the annotation editing software 11A in the terminal device P1 according to the embodiment can support not only the designation operation of the start point and the end point of the designated section by the input to the input field SF1 above, but also the designation operation of the start point and the end point of the designated section by the user by automatically correcting the position (time) of the start point and the position (time) of the end point of the input designated section to well-cut time even when the user's hand shake or the like occurs during the designation operation using the user interface such as the mouse or the touch panel.

Although various embodiments have been described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present invention. Components in various embodiments described above may be combined freely in a range without deviating from the spirit of the invention.

The present disclosure is useful as a display device and a display method that provide a voice section as a target to a user in an easy-to-understand manner and support improvement of convenience of annotation work of the user.

What is claimed is:

1. A display device comprising:
a processor;
a memory; and
a monitor, wherein
the processor is configured to
display a signal waveform of voice data on the monitor, and then receive a designation operation of a designated section designated by a user on the voice data, and determine one or more target sections in the designated section, and
generate a screen in which a frame line indicating each of the one or more determined target sections is superimposed on the signal waveform, and output the screen to the monitor.

2. The display device according to claim 1, wherein the one or more target sections are one or more learning target sections used for machine learning.

3. The display device according to claim 1, wherein the frame line has a polygonal shape other than a rectangle.

4. The display device according to claim 1, wherein the frame line has a circular shape other than a perfect circle.

5. The display device according to claim 2, wherein each of the one or more learning target sections is superimposed by the frame line having a shape of an ellipse, a triangle, or a rhombus.

6. The display device according to claim 2, wherein the processor is configured to calculate an average voice volume for each of the one or more learning target sections, and remove a learning target section in which the calculated average voice volume is determined to be less than a threshold value from a target of the machine learning.

7. The display device according to claim 2, wherein in a learning target section in which the processor determines that a total time of a section that is equal to or greater than a predetermined voice volume among the one or more learning target sections is less than a predetermined time, the processor is configured to correct time that is first equal to or greater than the predetermined voice volume to a start point of the learning target section.

8. The display device according to claim 2, wherein the processor is configured to remove the learning target section designated by a user operation among the one or more learning target sections from a target of the machine learning.

9. The display device according to claim 1, wherein the processor is configured to generate and output the screen including signal waveform data and spectrum data of the voice data.

10. The display device according to claim 9, wherein the processor is configured to generate the screen in which the frame line indicating a range of each of the one or more target sections is superimposed on any one of the signal waveform data and the spectrum data designated by a user operation.

11. The display device according to claim 1, wherein
the processor is configured to
divide the voice data for every predetermined time, and
correct time indicated by a start point or an end point of the designated section to a closest predetermined time among the divided predetermined time.

12. A display device comprising:
a monitor that displays voice data;
an input unit configured to receive a designation operation of a designated section by a user on voice data in a state that a signal waveform of the voice data is displayed on the monitor; and
a processor configured to determine one or more target sections from the designated section, and generate a screen in which a frame line indicating each of the one or more determined target sections is superimposed on the signal waveform, and output the screen to the monitor.

13. A display method performed by a terminal device that generates data used for voice identification, the display method comprising:
receiving a designation operation of a designated section designated by a user on voice data in a state that a signal waveform of the voice data is displayed on a monitor, and then determining one or more target sections in the designated section; and
generating a screen illustrating the one or more determined target sections on the signal waveform, and outputting the screen.
